(19) United States
(12) Patent Application Publication
(10) Pub. No.: US 2014/0125786 A1
(43) Pub. Date: May 8, 2014

(54) TOPPING FOIL VISION VERIFICATION SYSTEM

(71) Applicant: DATACARD CORPORATION, Minnetonka, MN (US)

(72) Inventor: Peter E. Johnson, Maple Grove, MN (US)

(73) Assignee: DATACARD CORPORATION, Minnetonka, MN (US)

(21) Appl. No.: 14/128,664

(22) PCT Filed: Jun. 27, 2011
(86) PCT No.: PCT/US11/41968

§ 371 Date: Dec. 23, 2013

(51) Int. Cl. G06K 9/00

(52) U.S. Cl. CPC G06K 9/00442
USPC 348/61

(57) ABSTRACT

A method and a system that are used to indirectly read embossed characters on a personalized document for verifying or recognizing the embossed characters. The method and system digitize an image of the embossed characters that is formed on a foil when applying coloration material from the foil to the embossed characters on the personalized document. The captured image on the foil is then used to verify and/or recognize the embossed characters on the personalized document.

### FIELD

This disclosure relates to vision verification, more particularly to a vision verification system for indirectly verifying or recognizing embossed data, for example, raised characters on a personalized document.

### BACKGROUND

In certain applications, embossed characters, such as lines, numbers, letters, symbols, etc., on a personalized document, e.g., a credit card, need to be verified or recognized. Prior approaches used, include imaging the card directly using a digital camera and an illumination source such as a Cloudy Day Illuminator (CDI) so that the embossed characters thereof can be verified or recognized by digitizing the image of the embossed card.

### SUMMARY

A method and a system are described herein that are used to indirectly read embossed characters on a personalized document for verifying or recognizing the embossed characters. The described method and system digitize an image of the embossed characters that is formed on a foil when applying coloration material from the foil to the embossed characters on the personalized document. The captured image on the foil is then used to verify and/or recognize the embossed characters on the personalized document.

The method and system described herein eliminate the reflection problem associated with traditional direct vision methods in prior approaches. For example, in prior approaches, reflections appear as dark or white blobs located in any position on the character. This variability makes it difficult to determine the true character shape which leads to poor character recognition, especially for smaller characters. CDI may help limit undesired reflections. However, since the character shape is rounded on the topped surface, reflections still exist and the use of CDI does not completely solve the problem.

The method and system described herein can also overcome problems associated with reflections caused by of metallic backgrounds and/or in cases where characters are similar in color to the background, which cannot be overcome easily using direct vision methods.

In one disclosed example, a method of detecting embossed characters on a personalized document includes applying a coloration material from a portion of a foil to the embossed characters, to form an image of the embossed characters on the foil. The image is then digitized using a digital imager.

In another disclosed example, after a coloration material is applied to embossed characters on a personalized document from a portion of a foil, an image of the embossed characters that is formed on the foil is imaged using an imaging device. The image is then used to make a determination about the embossed characters on the personalized document or the quality of the application of the coloration material to the embossed characters.

In another disclosed example, a system for detecting embossed characters on a personalized document includes a transfer station at which a coloration material is transferred from a foil containing the coloration material onto the embossed characters on the personalized document. An imaging station is downstream from the transfer station, and includes an imager that images an image of the embossed characters that is created on the foil at the transfer station as a result of transferring the coloration material from the foil onto the embossed characters on the personalized document.

### DRAWINGS

FIG. 1 is a schematic view of one embodiment of a system for detecting embossed characters on a card.

FIG. 2 is a schematic view of another embodiment of a system for detecting embossed characters on a card.

FIG. 3 is a schematic front view of a card with embossed characters on it.

FIG. 4(a) is a schematic back view of a portion of a foil with an image of the embossed characters of FIG. 3, with the foil being illuminated by a backlight source.

FIG. 4(b) is a schematic front view of a portion of a foil with an image of the embossed characters of FIG. 3, with the foil being illuminated by a backlight source.

FIG. 5(a) is a schematic back view of a portion of a foil with an image of the embossed characters of FIG. 3, with the foil being illuminated by a front light source.

FIG. 5(b) is a schematic front view of a portion of a foil with an image of the embossed characters of FIG. 3, with the foil being illuminated by a front light source.

### DETAILED DESCRIPTION

A method and a system are described herein that is used to detect embossed characters on a personalized document. The personalized document is, for example, a credit card, an identification card, a gift card, or a passport. The term personalized document refers to a document to which embossed characters are applied by one party and which document is intended for another party, regardless of whether or not the embossed characters or any other information on the document relate to personal information of the another party.

The described method and system can digitize an image of the embossed characters on a foil that is created on the foil by applying coloration material from the foil to the embossed characters on the personalized document. The image can be used to verify and/or recognize the embossed characters.

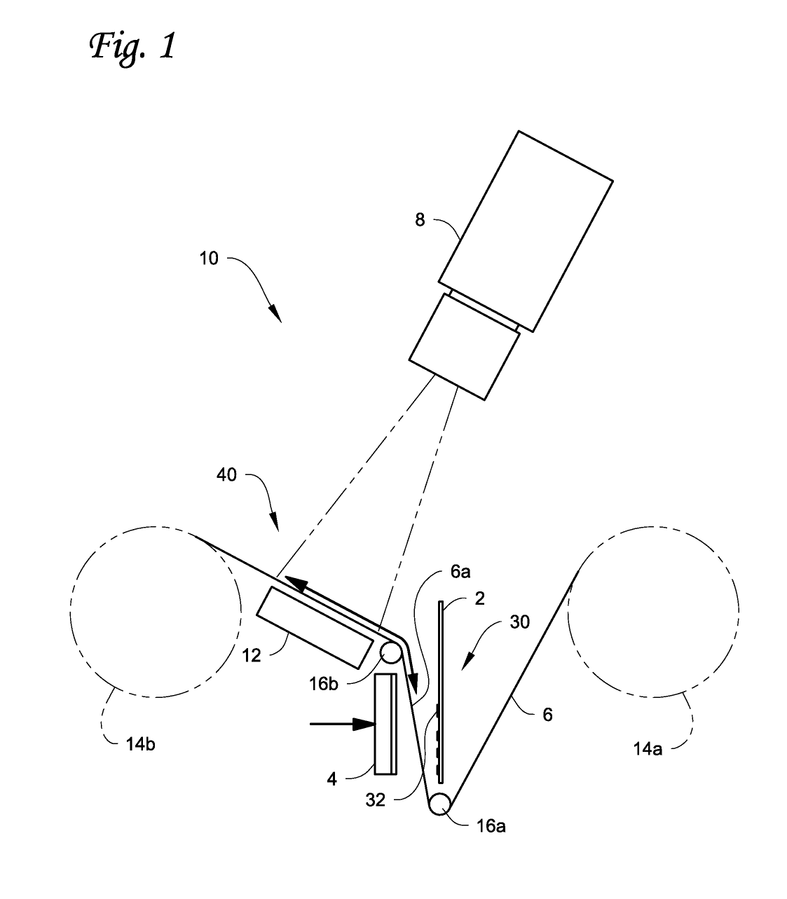

FIG. 1 illustrates a schematic view of an embodiment of a system 10 for detecting embossed characters on a card 2. A foil 6 is transferred using a transport mechanism along a transport path. The foil 6 is transferred from a foil supply 14a at one end of the transport path, a foil take up 14b at the other end of the transport path, and rollers 16a, 16b positioned along the path between the two ends to change the direction of transfer. Any number rollers can be used to control the transfer of the foil. It is appreciated that other appropriate mechanisms instead of rollers can be used to control the transfer of the foil.

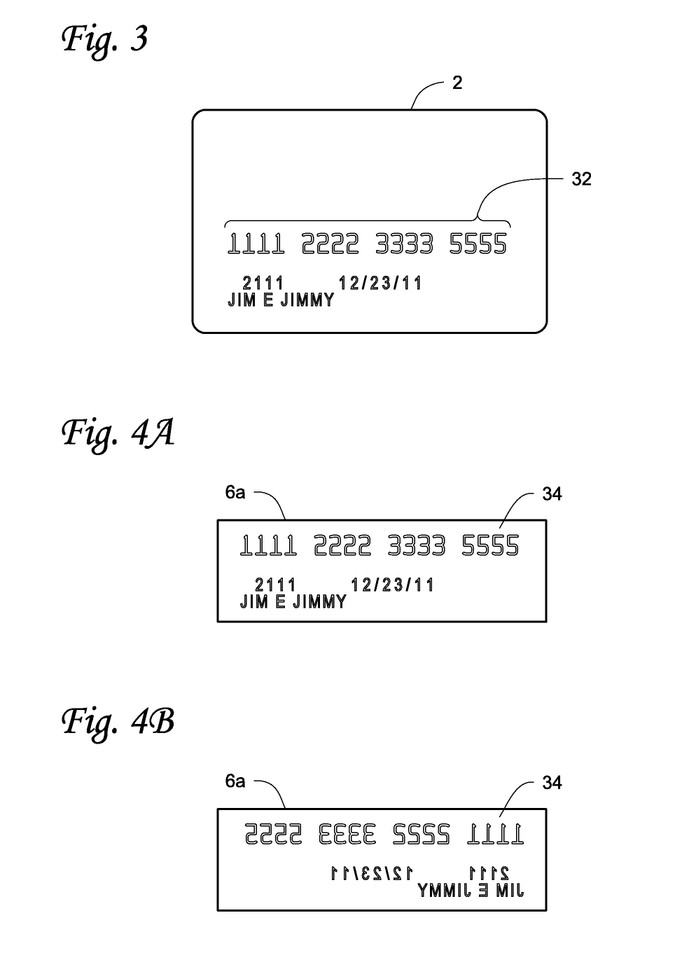

The exemplary card 2 is illustrated in FIG. 3. The card 2 can be made of a plastic material, for example polyvinyl chloride (PVC) or other suitable plastic as well as non-plastic materials, e.g., metals. The card 2 has embossed characters 32 on one side, including lines, letters, numbers, symbols, etc. The card 2 can also include printed material, a hologram(s), a magnetic stripe, an integrated circuit chip, etc. In the illustrated embodiment, the embossed characters 32 are characters that are indented from one side of the card and raised above the facing surface of the card. Alternatively, the embossed characters can be indented characters that are indented into one surface without being raised above the reverse surface. Therefore, as used herein, the term embossed characters is intended to include characters that are raised above the surface, as well as indented characters that are indented into one surface without being raised above the opposite surface.

The techniques for forming embossed characters, whether raised or indented, are well known to those having ordinary skill in the art.

In the case of embossed characters that are raised, the foil 6 is often called a topping foil. In the case of embossed characters that are indented, the foil 6 is often called indent foil. In either case, the foil 6 has two layers including a layer of coloration material carried by a carrier layer. In the case of topping foil, the coloration material is typically a metallic-colored material with a color selected from a multitude of standard colors such as silver or gold, as well as custom colors. In the case of indent foil, the coloration material is typically black or other color to make viewing of the indented characters easier. The carrier layer is typically a polyester material. However, any foil having the ability to transfer a coloration material onto the embossed characters on the card 2 can be used as long as the coloration material can be applied to the embossed characters and a resulting image of the embossed characters can be formed on the foil.

Turning back to FIG. 1, the system 10 includes a transfer station 30 at which the coloration material from the foil 6 is transferred to the embossed characters. In the case of raised embossed characters, the transfer station 30 is located downstream from an embossing mechanism used to form the raised characters. The transfer station 30 could be part of the same assembly as the embossing mechanism, or a separate assembly from the embossing mechanism. In the case of indented characters, the transfer station 30 is typically part of the mechanism used to create the indented characters as would be understood to those having ordinary skill in the art.

The system 10 can be part of a module of a modular document processing system separate from other modules in the system. Alternatively, the system 10 can be part of a desktop document processing system where the elements of the system are disposed within the same housing along with an embossing mechanism.

After the card is embossed, the card 2 is positioned in the transfer station 30 with the embossed characters 32 facing a portion 6a of the foil. The construction and operation of the transfer station 30 is well known to those persons having ordinary skill in the art. The transfer station 30 includes a heated platen 4 positioned parallel to the card. The platen 4 is movable toward and away from the card to press the portion 6a of the foil against the embossed characters on the card 2 thereby transferring the coloration material to the tips of the embossed characters. The construction of a transfer station for transferring coloration material to indented characters is also well known, such as described in U.S. Pat. No. 7,866,904.

The transfer of the coloration material from the foil to the embossed characters creates an image of the embossed characters on the foil. For example, as shown in FIGS. 3, 4(a) and 4(b), the raised characters 32 on the card 2 create an image 34 on the foil portion 6a. The characters 32 and their image 34 are complementary to each other in thickness/depth. FIG. 4(a) is a back view of the image 34, i.e., viewed through the foil. FIG. 4(b) is a front view of the image 34, i.e., viewed from the foil side, where the image 34 is a mirror image of the characters 32. In the image 34, characters and their relative positions are maintained.

In a proper transfer of the coloration material, the character shapes in the image are well defined with sharp perimeter edges. Also, if a portion of the embossed characters on the card is not present, there would be no counterpart in the image on the foil. If the embossed characters on the card are incorrect or not what is expected, the image would show the incorrect embossed characters. If a portion of the embossed characters is out of place, the counterpart in the reserve image is also out of place. If there is a variation of the depth (i.e. the raised distance above the card surface) or thickness (i.e. the distance between the sides of the embossed characters), those variations would be reflected by corresponding variations in the image on the foil.

Therefore, the image 34 on the foil can be used to glean information about the embossed characters on the card, such as the accuracy and quality of the embossing. The image can also provide information about the quality of the coloration material transfer to the embossed characters. So imaging the image on the foil 6 can provide valuable information about the embossed characters and/or the colorant material transfer to the embossed characters.

After the coloration material is transferred to the embossed characters and the image 34 is formed, the portion 6a of the foil is transferred in a downstream direction along the transport path to an imaging station 32. Alternatively, the imaging station 32 can be moved toward the foil to image the image.

The imaging station 40 includes an imaging device 8 which is used to image the image 34. The imaging device 8 can be any device suitable for capturing an image of the image 34 on the foil portion 6a. For example, the imaging device 8 can be a digital imager. It is contemplated that the imaging device 8 can also be a non-digital imager, e.g., a film camera, which is then digitized using suitable analog to digital conversion techniques.

In the embodiment shown in FIG. 1, the imaging device 8 is a digital imaging camera with the foil 6a being illuminated by a backlight light source 12. The imaging device 8 is positioned on one side of the foil facing the coloration material, and the light source 12 is opposite the digital imager, on the carrier side of the foil. It is contemplated that the positions of the imaging device 8 and light source 12 can be switched, with the imaging device 8 positioned on the carrier side of the foil and the light source positioned on the opposite side of the foil. It is preferred to use a backlight to optimize foreground to background contrast in the foil. However, the light source 12 and the digital imager 8 can be disposed at any other positions, including on the same side of the foil, as long as the image 34 on the foil portion 6a can be illuminated by the light source and the image can be imaged by the digital imager.

The light source 12 can emit visible or non-visible light, in any wavelength, for example infrared, ultraviolet, etc., suitable for use with the imaging device 8. Light from the light source 12 impinges on the portion 6a of the foil, transmits through the foil, and illuminates the image 34 thereon. For example, light transmitted through the voids of the image characters on the foil has stronger intensity than any light that transmits through other portions of the foil. The contrast in light intensity due to the voids of the image 34 on the foil is recorded by the imaging device 8.

The imaging device 8 is, for example, a digital camera that includes electronic imaging sensors to record the image 34 on the foil 6a illuminated by the light source 12. Any digital imaging device that can record the image of the image 34 can be used. The imaging device can record a black-white, grey tone, or color image of the image 34.

FIGS. 4(a) and 4(b) illustrate the images recorded by an imaging device, such as the imaging device 8, for the foil 6a with the image 34, with the foil 6a being illuminated by a backlight light, such as the backlight source 12 of FIG. 1. FIG. 4(a) is a back view of the image 34 and FIG. 4(b) is a front view of the image 34. It is to be understood that in real life, under the illumination of a backlight source, the image of characters would appear white (positive) and the background would appear black (negative). It would be appreciated that recorded images for the foil could be a grey tone or color image.

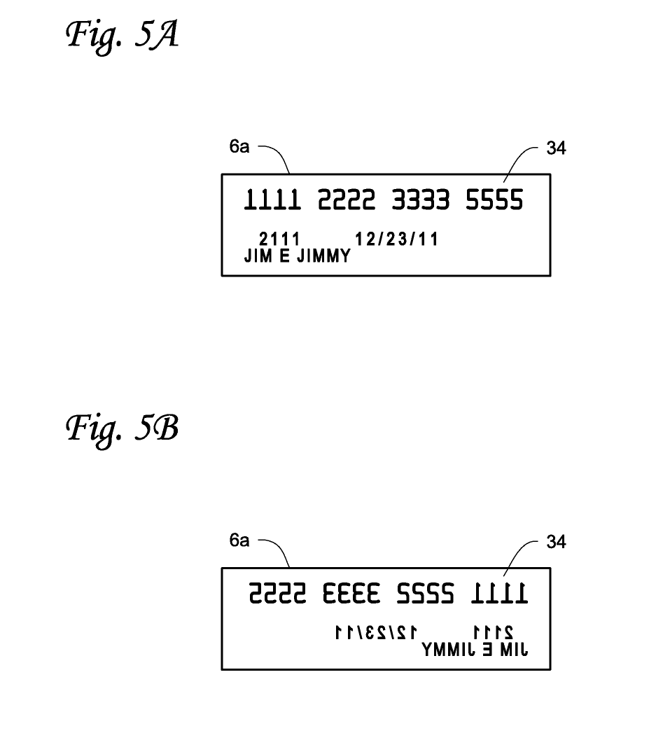

FIGS. 5(a) and 5(b) illustrate the images recorded by an imaging device, such as the imaging device 8, for the foil 6a with the image 34, with the foil 6a being illuminated by a front light source. FIG. 5(a) is a back view of the image 34 and FIG. 5(b) is a front view of the image 34. In the illustrated example, the image of characters is black and the background is white. It would be appreciated that recorded images for the foil could be a grey tone or color image.

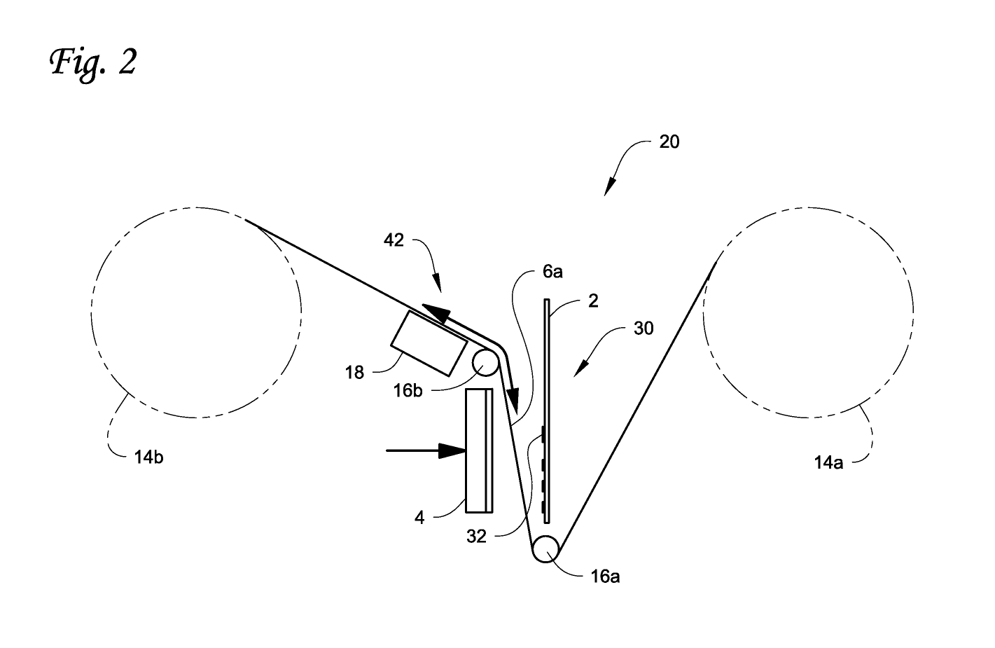

FIG. 2 shows another example of an imaging station 42 of a system 20 for detecting embossed characters on a card that uses an imaging device 18 in the form of a contact image sensor (CIS) 18. The construction and operation of the CIS is known. For example, the CIS 18 has an image sensor placed in near direct contact with the portion 6a of the foil. The CIS 18 includes a linear array of detectors, covered by a focusing lens and can be flanked by light-emitting diodes (LEDs) for illumination. It is to be understood that CIS can also use backlight for illumination. The CIS 18 can be positioned on the carrier layer side as shown in FIG. 2 or on the opposite side (i.e. on the coloration material layer side) to digitize the image 34.

Once the image 34 is imaged, the image can be processed and used to make various determinations about the embossed characters 32 on the card 2 or the quality of the application of the coloration material to the embossed characters. The image can be processed by conventional optical character verification (OCV) and/or optical character recognition (OCR) algorithms. OCV operates by reading data associated with the under test image and comparing the data against expected data associated with an expected image, and determining if any differences exist between the images being compared. OCR operates by defining all possible characters and the number of characters in the under test image and determining the best fit of the characters and return data.

For example, the quality of the embossed characters 32 on the card 2 can be assessed by checking the image of the image 34. The quality can be checked by automatically comparing the image against an expected image, or by automatically comparing individual characters in the image against expected characters. For example, algorithms allow a user to set thresholds of acceptance. Deviations from expected bitmap for each character are used to score the likelihood the character is as expected or better than another one in the font or character table. The deviations include, for example, failures caused by voids or additions to the shape. Prior approaches normally are not capable of determining what is causing the failures. In the method and system described herein, character definition is greatly enhanced, and therefore, could lead to more advanced algorithms to provide more advanced fault definition and detection.

The quality can also be checked by a person visually reviewing the image created by the imaging device 18 and visually looking for quality issues.

The quality of the embossed characters includes, but is not limited to, completeness of the characters including whether characters are partially or completely missing, correctness of the characters, sizes and other dimensional characteristics of the characters, and positions of the characters on the card and relative to each other.

In some embodiments, variations in the intensity of the light through the characters in the image will create variations in the resulting image. The intensity of light passage will be based on how much or how little of the coloration material transfers on to the embossed characters. Therefore, variations in light intensity in the image can be used to assess the quality of the coloration material transfer onto the embossed characters.

After the image on the foil portion 6a is imaged by the imaging device, the foil can be transferred reversely along the transport path as indicated by the double headed arrow in FIGS. 1 and 2, to move the foil portion 6a toward the transfer station 30. Because the imaging station is downstream from the transfer station 30 a certain distance, a significant portion of the foil 6 needs to be advanced to bring the foil portion 6a into position in the imaging station. This results in advancement of foil that does not contain the image that could be used to apply colorant material to the embossed characters on another card. By reversing the foil 6, the foil can be reversed to a position such that the distance between the image 34 and a new image created on the foil resulting from applying colorant material to the embossed characters on a new card is minimized, thereby reducing foil use and waste. In order to reverse the foil, the drives of the foil take-up 14b and the foil supply 14a need to be reversible.

The method and the system described herein can inspect any embossed line positions, and character sizes including, but not limited to, 7 or 10 characters per inch (CPI). By imaging the foil rather than the card itself, the effects and problems associated with imaging a wide range of card background print and print colors is avoided.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of detecting embossed characters on a personalized document, comprising:
applying a coloration material from a portion of a foil to the embossed characters, an image of the embossed characters thereby being formed on the foil;
imaging the image on the foil using a digital imager.

2. The method of claim 1, further comprising:
pressing the foil against the embossed characters using a platen, and thereafter transferring the foil in a first direction along a transport path to position the portion of the foil at a position to be imaged by the digital imager.

3. The method of claim 2, wherein after imaging the image, transferring the foil in a reverse direction opposite the first direction along the transport path.

4. The method of claim 1, wherein the embossed characters are raised characters or indented characters.

5. The method of claim 1, wherein the digital imager is a digital camera, and a light source being positioned to illuminate the portion of the foil having the image.

6. The method of claim 1, wherein the digital imager is a contact image sensor, the contact image sensor being positioned on one side of the portion of the foil.

7. The method of claim 1, wherein the personalized document is a plastic card.

8. A method, comprising:
after a coloration material is applied to embossed characters on a personalized document from a portion of a foil, imaging an image of the embossed characters that is formed on the foil using an imaging device, and using the image to make a determination about the embossed characters on the personalized document or the quality of the application of the coloration material to the embossed characters.

9. The method of claim 8, wherein after imaging the image, moving the foil in a direction toward the location where the coloration material was applied to the embossed characters.

10. The method of claim 8, wherein the embossed characters are raised characters or indented characters.

11. The method of claim 8, wherein the imaging device is a digital camera, and a light source being positioned to illuminate the portion of the foil having the image.

12. The method of claim 8, wherein the imaging device is a contact image sensor.

13. The method of claim 8, wherein the personalized document is a plastic card.

14. A system for detecting embossed characters on a personalized document, comprising:
a transfer station at which a coloration material is transferred from a foil containing the coloration material onto the embossed characters on the personalized document; and
an imaging station downstream from the transfer station, the imaging station including an imager that images an image of the embossed characters that is created on the foil at the transfer station as a result of transferring the coloration material from the foil onto the embossed characters on the personalized document.

15. The system of claim 14, further comprising a foil transport mechanism for transporting the foil between the transfer station and the imaging station, and the foil transport mechanism is reversible so that the image on the foil can move from the transfer station to the imaging station and from the imaging station back toward the transfer station.

16. The system of claim 14, wherein the imager is a digital camera, the digital camera being disposed at one side of the foil; and the imaging station further includes a light source disposed on the other side of the foil to illuminate the foil including the image.

17. The system of claim 14, wherein the imager is a contact image sensor.

18. The system of claim 14, wherein the system is part of a module of a modular document processing system, or the system is part of a desktop document processing system where the transfer station and the imaging station are disposed within the same housing along with an embossing mechanism.

19. The system of claim 14, wherein the embossed characters are raised characters or indented characters.

20. The system of claim 14, wherein the personalized document is a plastic card.
